(19) United States
(12) Patent Application Publication
(10) Pub. No.: US 2005/0273424 A1
(43) Pub. Date: Dec. 8, 2005

(54) Methods and apparatus for pre-trade analysis

(76) Inventors: Andrew F. Silverman, Holmdel, NJ (US); Ping Xia, Belle Mead, NJ (US); John A. Fanelli, Montclair, NJ (US)

Correspondence Address: Buckley, Maschoff & Talwalkar LLC, Five Elm Street, New Canaan, CT, 06840, US

(21) Appl. No.: 11/124,816

(22) Filed: May 9, 2005

Related U.S. Application Data
(60) Provisional application No. 60/569,335, filed on May 7, 2004.

(51) Int. Cl. G06F 17/60

(52) U.S. Cl. 705/39

(57) ABSTRACT

A method and system for a pre-trade analysis of a desired securities order, the method including, in some embodiments, receiving user input that indicates a desired securities order to evaluate, identifying a desired level of risk to associate with the desired securities order to evaluate, analyzing the desired securities order based on the desired level of risk using at least one of a plurality of securities trading algorithms, and displaying an information screen depicting information associated with the desired securities order based on the analyzing, wherein the information screen provides a graphical representation of the analysis prior to an execution of the desired securities order.

### CROSS REFERENCE TO RELATED APPLICATION

This application is related to U.S. Provisional Patent Application Ser. No. 60/569,335, filed on May 7, 2004, entitled “METHODS AND APPARATUS FOR PRE-TRADE ANALYSIS”, the contents of which are incorporated herein by reference for all purposes.

### FIELD

The present invention relates to electronic trading of securities and other financial instruments. In some embodiments, the present invention relates to methods and apparatus for performing pre-trade analyses of orders.

### BACKGROUND

Various forms of electronic trading are used in today's financial community. Generally, electronic trading allows traders to place orders through a user device such as a desktop computer.

Architectures of electronic trading systems vary widely. In some systems, a trader interacts with an electronic trading platform presented by the user device. The electronic trading platform may be an internally-developed system or an off-the-shelf system, such as the REDIPlus™ system. The electronic trading platform may communicate with pools of liquidity directly or through a routing and order management network, such as REDINet™. Such pools of liquidity, which may also be thought of as trading market places, include listed exchanges, ECNs (Electronic. Communication Networks), market makers, options exchanges, futures exchanges, and the like. An electronic trading platform and/or management network may also communicate with in-house back-end systems to provide trade reporting and tracking functions to the trader.

Many electronic trading platforms and management networks are currently available, each providing specific features. Many of these features are intended to clearly present market information to a trader, and others are intended to facilitate trading functions.

In recent years, the number of trading market places has greatly increased, and so have the types of orders and other service options provided by the trading market places. Moreover, the various trading market places increasingly offer types of orders and other service options that differ from market place to market place. Improvements in trading platforms are now needed to help in guiding traders through the veritable maze of possibilities that the current trading environment offers.

### BRIEF DESCRIPTION OF THE DRAWINGS

FIG. 1 is an exemplary block diagram of a system, a trading network, according to some embodiments herein;

FIG. 2 is an exemplary illustration of an order processing server, in accordance with the trading network of FIG. 1;

FIG. 3 is an exemplary illustration of a user device, in accordance with the trading network of FIG. 1;

FIG. 4 is a flow diagram that illustrates an exemplary process for a pre-trade analysis of a desired securities order, in accordance with some embodiments herein; and

FIG. 5 is an exemplary user interface for receiving user input and displaying information associated with a pre-trade analysis of a desired securities order.

### DETAILED DESCRIPTION

In general, and for the purposes of introducing concepts of embodiments of the present invention, a pre-trade analytic system may allow traders to perform analytics on different orders prior to making a trade. Some embodiments provide a tool which theoretically calculates and projects the cost of the proposed trade by visually weighing the market impact cost versus the execution risk. Embodiments allow traders to estimate a cost or exposure to a trade and/or optimize their trades prior to submission. In some embodiments, at least one and in some other embodiments a number of securities trading algorithms may be used to analyze a desired securities order (i.e., trade) prior to the submission of the trade for execution. In some embodiments hereof, results of the analysis are graphically presented, at least in part, for concise and intuitive interpretation of the pre-trade analysis.

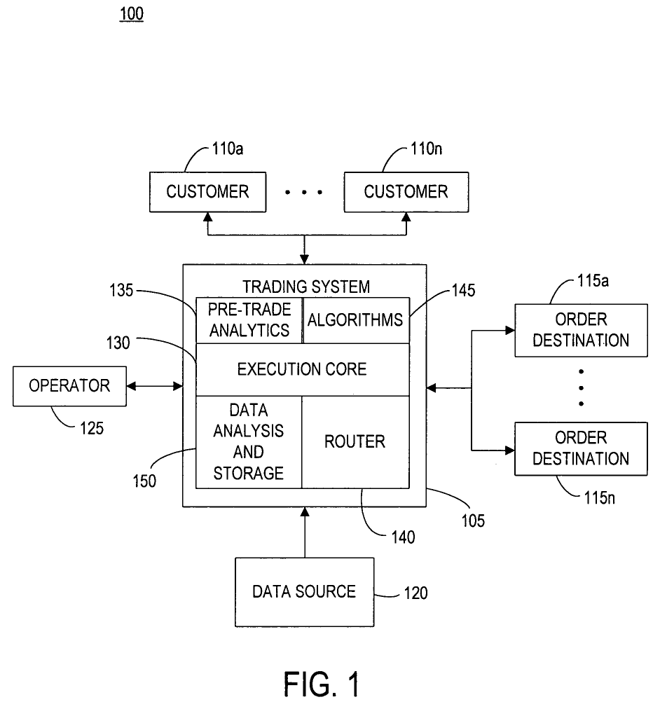

Various features of some embodiments hereof may be understood by referring to FIG. 1 that depicts a block diagram according to one embodiment of a trading network 100. Trading network 100 includes a number of different components that cooperatively operate to process and execute securities trading analysis and order submissions, in accordance with some embodiments herein.

Trading network 100 includes an order processing server 105 in communication with one or more user device(s) 110ₐ-110ₙ, a plurality of order destinations 115ₐ-115ₙ, and a source 120 of market data. User device(s) 110ₐ-110ₙ may be provided to and/or accessed by a customer using the resources of trading network 100. A customer may be an entity, including an individual, an organization, a business and a customer, employee or other associated with such an entity and/or provided access to trading network 100.

It should be appreciated trading network may include more, fewer, and alternative components and configurations than those depicted in the exemplary FIG. 1. For example, in some embodiments order processing server 105 may function as a host for user device(s) 110ₐ-110ₙ and may operate to receive and execute financial instrument trading orders on behalf of users of user devices 110ₐ-110ₙ. In some embodiments, order processing server 105 may function to timestamp orders when received and to assign an order identifier, sequence number, or other identifiable tracking indicia to each order.

In an instance input from the user via user device(s) 110ₐ-110ₙ indicates selection of a particular order destination, order processing server 105 may implement the user's selection by routing the order to the selected order destination. When an order as defined by the user does not prescribe an order destination, the order processing server 105 may operate to automatically route the order to one or more of the order destinations selected by the order processing server 105 based on a number of criteria. Such criteria may include at least one attribute of the order. That is, based on an attribute of the order (e.g., size, type of security, etc.), processing server 105 may determine the order destination.

Order processing server 105 may operate to receive data and other input information from data source 120 concerning market conditions. Such data may include, for example, information concerning the current status of order books at the order destinations 115. Thus the data supplied by the data source 120 may include current price quotations for financial instruments to be traded via trading network 100. That is, data source 120 may provide substantially real-time current market conditions and information. Such current information, as will be discussed in greater detail below, may be advantageously used to in the pre-trade analysis of the securities order.

Order processing server 105 may receive historical data from data source 120. Order processing server 105 may also may maintain and update databases based on the data received from data source 120 and may provide market data to the users via the user devices 110.

While a single order processing server 105 is shown in FIG. 1, any number of order processing servers or devices providing similar functionality may be included in trading network 100. Similarly, any number of data sources 120, user devices 110, order destinations 115, or any other device described herein may be included in trading network 100 according to embodiments herein.

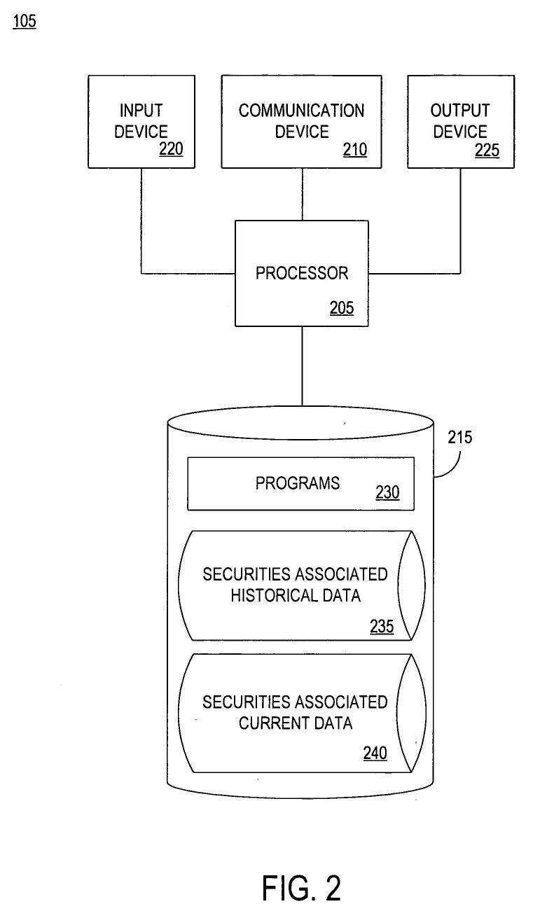

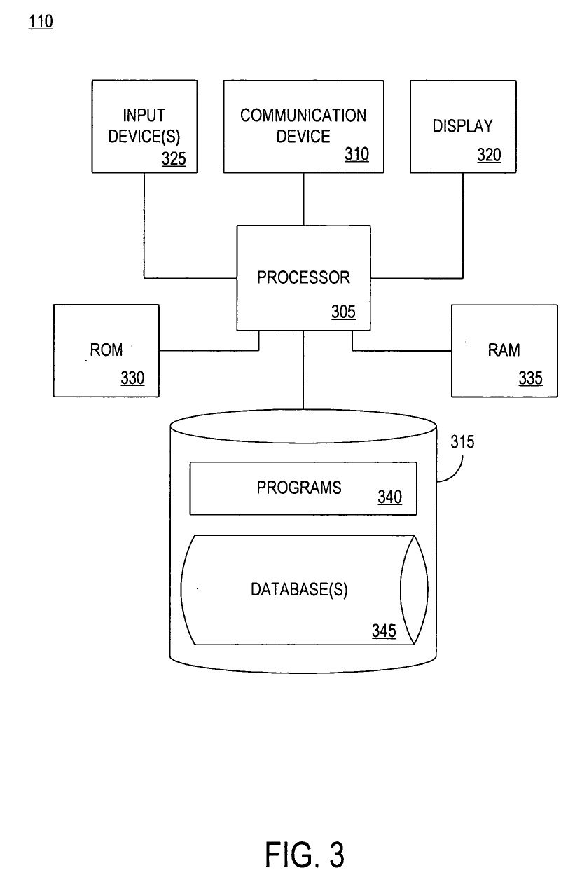

Each of the devices of trading network 100 may be formed of components or other devices capable of performing the various functions described herein. Accordingly, the functionality and the various configurations disclosed herein are encompassed by the present disclosure. Exemplary embodiments of order processing server 105 and user device 110 are further described below with reference to FIGS. 2 and 3, respectively.

An order destination 115 may include any computing device(s) operated by or on behalf of one or more order destinations. Each of order destinations 115 may be in communication with other devices described herein, such as order processing server 105 and data source 120, using communication, connectivity, and processing techniques and protocols known in the art.

As used herein, devices (e.g., order processing server 105, user devices 110, order destinations 115, and data source 120) may communicate, for example, via one or more communication networks. As an example, some or all of the devices may be in communication via an Internet Protocol (IP) network such as the Internet. Some or all of the devices may be in communication via other types of networks such as an intranet, a Local Area Network (LAN), a Metropolitan Area Network (MAN), a Wide Area Network (WAN), a proprietary network, a Public Switched Telephone Network (PSTN), a wireless network, and any combinations thereof.

According to some embodiments, communication between some or all of the devices of trading network 100 may be via temporary computer communication channel (e.g., a logic path through which information can be exchanged). That is, a communication channel between one or more of the various devices disclosed herein may be established and discontinued as appropriate (i.e., as needed). For example, order processing server 105 may exchange information with one of the order destinations 115 only when communication is necessary to transmit an order for execution by order destination 115 or to receive confirmation from the order destination 115 that the order was executed.

According to some embodiments, some or all of the devices of FIG. 1 may be computing devices and may communicate with other devices via a public computer communication network. That is, at least a portion of the communication network may be accessed by devices other than the devices depicted in FIG. 1. Note however, that information exchanged between order processing server 105 and some of the other devices in FIG. 1 may be encrypted or otherwise protected to prevent a third party from accessing, manipulating, understanding and/or misusing the information. In some embodiments, some or all of the devices may communicate over a private network. It is further noted that other types and measures of data security may be implemented and used in the various systems and methods herein.

In some embodiments and as mentioned above, the devices of FIG. 1 may be connected differently than as shown. For example, some or all of the devices may be connected indirectly to one another (e.g., via the Internet). Some embodiments hereof may include devices that are different from those shown. Also, while the devices of FIG. 1 are shown in communication with each other, the devices need not constantly exchanging data. Rather, communication may be established when necessary and severed at other times or always available but rarely used to transmit data. Moreover, although the illustrated communication links appear dedicated, each of the communication links may be shared by other devices.

The system of FIG. 1 includes functionality referred to as pre-trade analytics 135. Embodiments may utilize a number of different pre-trade analytics allowing traders to perform analyses of trades prior to submitting a trade for execution. Further, the system includes one or more security trading algorithms 145 that may be applied by the pre-trade analytics 135 functionality in order to perform a variety of analyses regarding a desired securities order or trade. In some embodiments, the pre-trade analytics 135 use the one or more security trading algorithms 145 in order to perform a variety of analyses regarding the desired trade.

In some embodiments, the one or more security trading algorithms 145 are each substantially self-contained modules that may be independently interfaced with pre-trade analytics 135 and order processing server 105. In this manner, trading system 100 and order processing server 105 may be customized to an application, context of use, customer, client, and other entity based on the one or more security trading algorithms 145 module provided for interaction with trading system 100 and order processing server 105.

Referring to FIG. 2, an embodiment of order processing server 105 is generally shown. In some embodiments, Order processing server 105 includes a computer processor 205 operatively coupled to a communication device 210 and a storage device 215.

Processor 205 may include one or more processors, and may, for example, include RISC-based and other types of processors. Processor 205 operates to execute processor-executable process steps so as to control various aspects of order processing server 105 and to provide desired functionality.

Communication device 210 may be used to facilitate communication with, for example, other devices (such as user devices 110, order destinations 115 and data source 120). Communication device 210 may, in some embodiments, be configured with hardware suitable to physically interface with desired external devices and/or network connections. For example, communication device 210 may include an Ethernet connection to a local area network through which order processing server 105 may receive and transmit information over the World Wide Web.

Storage device 215 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices.

In some embodiments, storage device 215 stores one or more programs 230 for controlling processor 205. Programs 230 may comprise processor-executable process steps of order processing server 105, and may include process steps that include processes provided in accordance with other aspects of the present disclosure to implement a pre-trade analysis, as further described herein below.

Processor 205 performs instructions of programs 230, and thereby may operate in accordance with the present disclosure. In some embodiments, programs 230 may be configured, at least in part, as a neural network or other type of program using techniques known to those skilled in the art to achieve the functionality described herein. In some embodiments, functionality implemented via programs 230 may include host server functions, order processing, and trade execution functions.

Any or all process steps of order processing server 105 may be read from a computer-readable medium, such as a floppy disk, a CD-ROM, a DVD-ROM, a Zip™ disk, a magnetic tape, or a signal encoding the process steps, and then stored in storage device 215 in a compressed, uncompiled and/or encrypted format. Processor-executable process steps being executed by processor 205 may typically be stored temporarily in RAM (not separately shown) and executed therefrom by processor 205. In some alternative embodiments, hard-wired circuitry may be used in place of, or in combination with, processor-executable process steps for implementation of processes according to embodiments of the present invention. Thus, embodiments of the present invention are not limited to any specific combination of hardware and software.

Storage device 215 may also store databases, including, for example, a database 235 containing historical current market condition data and a database 240 containing current market condition data (e.g., including current quotations for financial instruments). It should be appreciated that other databases may also be provided (e.g., order and execution data may also be stored in storage device 215).

There may also be stored in storage device 215 other (not shown) elements and/or devices that may be used in an operation of order processing server 105, such as an operating system, a database management system, other applications, other data files, and “device drivers” for allowing processor 205 to interface with devices in communication with communication device 210. These other elements and/or devices are known to those skilled in the art, and are therefore not described in detail herein.

Although not shown in the drawing, order processing server 105 may include or be operatively connected to one or more input and/or output devices to permit a system administrator or other user to provide input to the processor 205 or to receive output from the processor 205.

With reference to FIG. 3, there is shown an embodiment of a user device 110. As generally depicted, user device 110 includes a processor 305 operatively coupled to a communication device 310, a storage device 315, a display 320, one or more input devices 325, ROM 310 and RAM 312. Some or all of the hardware constituting user device 110 may be common to conventional personal computer (PC) hardware. Accordingly, processor 305 may be a Pentium® processor, for example, and communication device 310 may include a conventional communication port that enables user device 110 to exchange data with order processing server 105 via, e.g., an Ethernet connection.

Storage device 315 may include a hard disk drive and/or other mass storage device. Display 320 may include a CRT or a LCD flat panel computer monitor. Display 320 may include a screen (not separately shown) on which a user interface in accordance with various aspects of the present disclosure, as described in greater detail below, may be presented to a user of user device 110.

Input devices 325 may include a keyboard, keypad, a scanner, and/or a pointing device such as a mouse or trackball. ROM 330 may store basic input/output instructions and instructions used, for example, during boot-up or initialization of user device 110. In some embodiments, RAM 335 provides fast data storage and retrieval and may thus function as working memory for processor 305. RAM 335, in some embodiments, may temporarily store instructions corresponding to processor-executable process steps being executed by processor 305.

Storage device 315 may store one or more programs 340 that control operations executed by processor 305. Programs 340 comprise processor-executable process steps of user device 110, and may include process steps that constitute processes provided in accordance with various aspects of the present disclosure, as described greater detail herein below. Processor 305 performs instructions of programs 340, and accordingly may effectively operate in accordance herewith. Programs 340 may include, for example, an operating system such as, for example, the Windows® Operating System, as well as device drivers and a client side application that enables user device 110 to interact with order processing server 105. A software program or programs that cause user device 110 to display a user interface (e.g., user input and analysis screen) hereof may reside primarily in order processing server 105 or in storage device 315. In some embodiments, user device 110 may be distributed between order processing server 105, user device 110, another computing device, and combinations thereof.

Storage device 315 may store one or more databases 345 that may be used to store, for example, data downloaded from order processing server 105. This data may include, for example, data concerning current market conditions and/or data indicative of choices that the user of user device 110 may be allowed to make in terms of a desired securities order to evaluate. Other parameters of financial instrument trading orders may also be stored in database 345. Database 345 may store, for example, past desired securities orders evaluated using trading network 100, preferences of the user (e.g., preferred risk tolerance/aversion, securities owned or of interest to the user, attributes of various accounts, etc.).

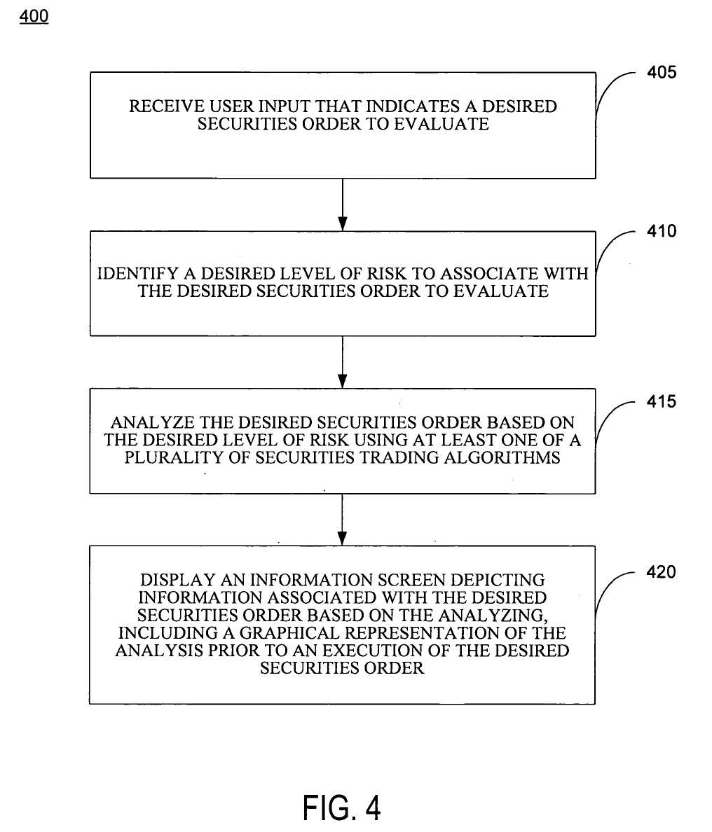

FIG. 4, in accordance with some embodiments herein, is a flow diagram that illustrates an exemplary process for a pre-trade analysis of a desired securities order, including graphically displaying a representation of information associated with the pre-trade analysis. The process shown in FIG. 4, generally indicated by reference numeral 400, may be performed by the trading system 105 shown in of FIGS. 1 and 2.

At operation 405, trading system 105 receives user input that indicates a desired securities order to evaluate. The user input may be manually or automatically transmitted and/or generated according to specific or general requests of a user. In some embodiments, the desired securities order to evaluate may be manually entered into a user device (e.g., user device 110) or automatically generated according to certain criteria such as market conditions, preferred thresholds and limits, economic announcements, etc. The user input of operation 405 may include a number of attributes to identify the desired securities order to evaluate such as, for example, a type of security, a market destination, a number or size of securities to include in the desired securities order to evaluate, a time span during which the desired securities order to evaluate is to be evaluated, etc.

In some embodiments, a portion of the user input may include identifying a desired time span for evaluating the desired securities order for the analyzing thereof. For example, regarding a desired securities order for selling 20,000 shares of a particular stock trading on the NYSE, it may be desirable to evaluate the order over a period of 4 hours. That is, the 20,000 shares of stock are sold over a 4-hour time span.

At operation 410, system 105 identifies a desired level of risk TO associate with the desired securities order to evaluate. In some embodiments, the desired level of risk corresponds to a risk level (e.g., costs, exposure to market volatility, etc.) a user is willing or is most comfortable with accepting regarding the desired securities order. It should be appreciated that since process 400 provides a pre-trade analysis of the desired securities order, the risk level referred to at operation 410 may be varied to differ from that that a user may actually be comfortable with accepting (at least prior to the pre-trade analysis). That is, since process 400 provides a pre-trade analysis of the desired securities order before the desired securities order is submitted for execution in any particular securities market, a user is free to evaluate the desired securities order using a variety of (if desired) levels of risk without actually being exposed to a potential risk.

In some embodiments, process 400 may use more than one risk level in analyzing the desired securities order. For example, in an instance the level of risk to associate with a desired securities trade is characterized on a level from 1 to 10, then the desired securities order may identify 10 (or fewer) risks levels at operation 410.

At operation 415, the desired securities order is analyzed based on the desired risk level indicated at operation 410 using at least one of a plurality of security trading algorithms. Process 400 may provide the plurality of security trading algorithms, at least one of which is used thereby to analyze and evaluate the desired securities order. The desired level of risk may have an effect on the analysis since risk level (e.g., costs to execute the trade, exposure to volatility, etc.) and may impact a projected performance of the desired securities order if submitted for execution to a security market.

The at least one of the plurality of security trading algorithms used to analyze the desired securities order may comprise a number of logic-based rules for guiding the trading of the desired securities order. Note, process 400 may further include a process (either separate or part of those depicted in FIG. 4) of providing the user an opportunity to selectively designate which one(s) of the plurality of the security trading algorithms to use in the analysis of operation 415. In some embodiments, a user or other entity may select from a number of the plurality of trading algorithms (also referred to as a trading “strategy”). In some instances, the plurality of trading algorithms available for selection by a user may be determined and/or limited by an attribute of the desired trading security order, the user or entity using the system, or the number and type of trading algorithms provided in a particular implementation of trading system 105.

Accordingly, at least one of the plurality of the securities trading algorithms used in the analyzing of operation 415 may be selectively designated by a user. Also, in some embodiments herein, methods herein may further include providing the at least one of the plurality of the securities trading algorithms used in the analyzing.

At operation 420, an information screen depicting information associated with the desired securities order based on the analyzing is displayed. The information screen includes a graphical representation of the analysis and is provided prior to, if any, an execution of the desired securities order. In some embodiments, the graphical representation of the information associated with the analysis is provided in a concise manner that is visually intuitive to understand by a user. The graphical representation may include for example, graph(s) of various formats (e.g., bar, pie, etc.), color-coded symbols and indicia, icons, etc. and other visual clues to facilitate a clear presentation of the pre-trade analysis information in graphical form.

It should be appreciated that the various operation of process 400 may vary in order, unless specifically disclosed herein as being contrary to the present disclosure. The sequence of operations in FIG. 4 is provided by way of example.

In some embodiments, a process of the present disclosure (e.g., process 400) may include an operation to execute the trade of the desired security order after the analysis process (e.g., 415) of the method. In this manner, a user may have the benefit of the analysis using the at least one of the plurality of the security trading algorithms prior to a submission and execution of the desired security order. At least a part of the user's consideration in deciding whether to submit the desired securities order may be the risk level identified with the desired securities order and associated therewith. Accordingly, a decision whether to submit the security order to a market may be made with knowledge of a projected performance of the security order based on the logic and rules of the at least one of the plurality of the security trading algorithms.

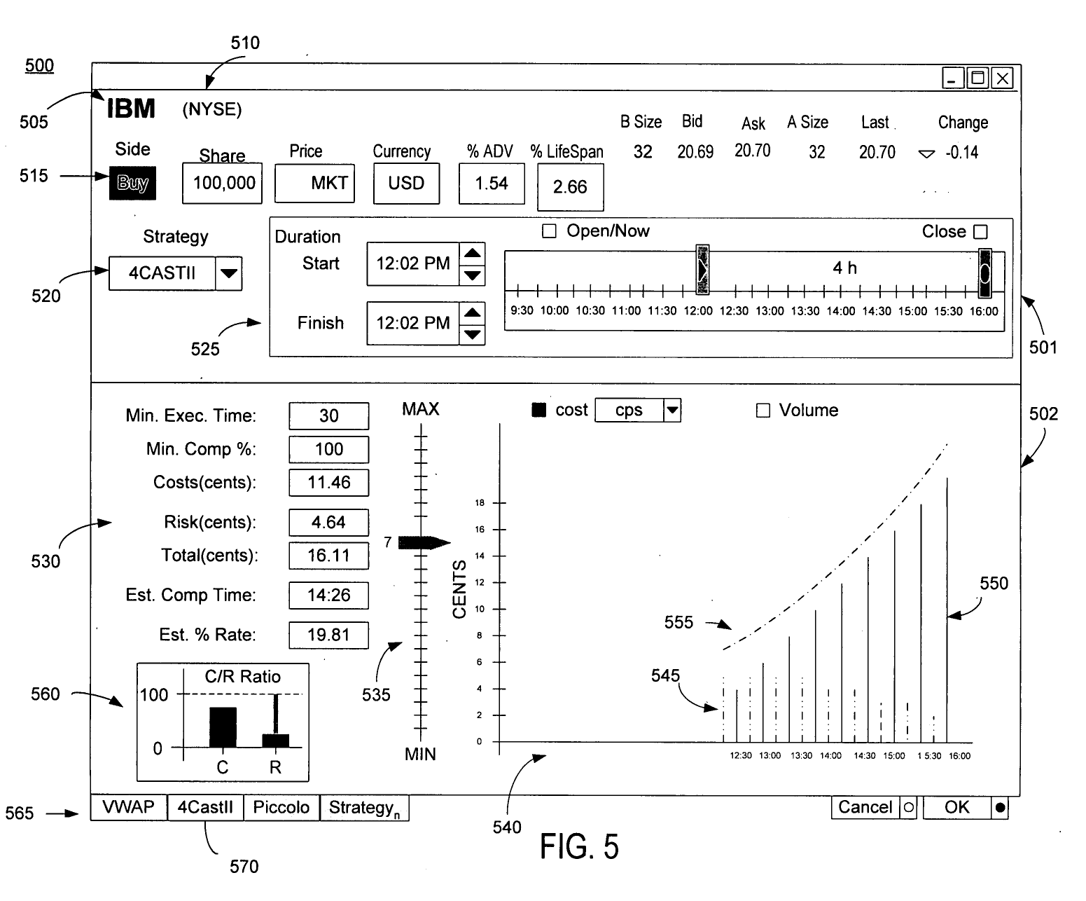

FIG. 5 provides an exemplary user interface for receiving user input and displaying information associated with a pre-trade analysis of a desired securities order, generally at reference numeral 500. The user interface 500 may generally be divided into two areas, a user input area 501 and an analysis representation area 502. User input area 501, for FIG. 5, includes roughly a top portion of the user interface screen 500 whereas the analysis representation area 502 generally includes a lower portion of the user interface screen 500.

It should be appreciated that in some embodiments, the specific geographies of a user interface occupied by the user interface area 501 and the analysis representation area 502 may be varied from that shown in FIG. 5. In some embodiments, a user may configure the layout of the user interface according to, for example, a user preference.

In some embodiments herein, user input area 501 includes space for indication of the particular security constituting the desired security order. For example, an identifier such as a stock symbol 505 and associated stock exchange 510 may be indicated in the user input area 501. Upon submitting user input including the particular security (e.g., IBM stocks), the system may automatically retrieve other information associated with the particular security such as current market information as shown in area 515 of the user interface screen 500. In some embodiments, at least a portion of area 515 information may be provided by the user (i.e., user input) such as, for example, whether the user is on the “buy” side or “sell” side of the desired securities order, the number of shares to include in the desired securities order. Certain portions of area 515 of the user interface screen 500 that may be populated by real-time and/or historical data may include, for example, the currency, percentage of the average daily value the desired securities order represents (% ADV), the percentage of the lifespan a specified time span for evaluating the desired securities order represents (% LifeSpan), and other market information relevant to the desired securities order, as understood by those in the art (e.g., B Size, Bid, Ask, A Size, Last, etc.).

User input may include a duration or time span for the proposed desired securities order to evaluate, as shown at area 525. Area 525 provides a mechanism for a user to provide a start time and a stop time. The start and stop times may be input directly, using the illustrated drop-down menus, or using the illustrated slide bars.

User interface 500 includes user-selectable strategy 520 that facilitates a user selectively designating which one(s) of a plurality of securities trading algorithms 565 to use in the pre-trade analysis of the desired securities order. User-selectable strategy 520 may be presented in the form of a drop-down menu as shown in FIG. 5. Other implementations (not shown) for presenting the user with an option of choosing at least one of the plurality of the securities trading algorithms 565 (i.e., strategies) may also be provided without departing from the scope of the present disclosure.

The particular plurality of the securities trading algorithms 565 provided as part of user interface 500 may vary depending on a configuration or implementation of the systems and methods herein. The particular plurality of the securities trading algorithms 565 included in user interface 500, for example, may be determined by the user's access rights, an administrator or service provider's preference, a capability of a system executing the method of the present disclosure, and other factors, including the availability of a particular securities trading algorithm in a format compatible with the systems and methods herein.

Accordingly, in some embodiments herein, the plurality of the securities trading algorithms 565 have an interface compatible with a system or device for executing the methods hereof. For example, the plurality of the securities trading algorithms 565 may be implemented as substantially independent operating modules of coded instructions that can be “plugged” into a system (e.g., 100) as needed and as made available in a format and structure that can interface with the system. In this manner, the systems and methods herein may be customized and scaled in a flexible operating context.

Analysis representation area 502 includes information 530 relevant to the analysis of the desired securities order based on the used securities trading algorithm 520 selected from the plurality of securities trading algorithms 565. Such relevant information may include the projected costs for executing the order, the projected associated risks for executing the order, and the projected associated total costs (costs+risks) for executing the order. The costs, risks, and total costs may be provided on a per security unit basis (e.g., cost per share, cps), as shown in FIG. 5.

As related to information 530, an expected trading cost displays the estimated, average cost (cents per share) associated with the desired securities order to be submitted at the estimated completion time (Estimated Comp Time). A stock volatility cost displays the estimated, average risk (cents per share) associated with the desire securities order to be submitted at the estimated completion time. The estimated total cost displays the estimated, average total cost (cents per share) associated with the desired securities order. The expected participation rate displays the estimated percentage of the historical average market volume that will be executed in the time interval defined in between the start time and estimated completion time fields.

It should be appreciated that the particular information 530 relevant to the analysis of the desired securities order may vary based on the particular securities trading algorithm 520 selected and used from the plurality of securities trading algorithms 565.

A desired risk level 535 to associate with the desired securities order is included in the analysis representation area 502 of user interface 500. The desired risk level 535 is provided since it may be beneficial to a user (e.g., client, trader, etc.) have the level of desired risk used as a basis for the analysis in close visual proximity with the graphical presentation of the pre-trade analysis information. In this manner, a user may efficiently ascertain the results of the analysis by focusing on area 501 of the user interface screen 500. The level of desired risk may be indicated or, in some embodiments varied, using the slide bar mechanism shown in FIG. 5 or other user input mechanisms for same (not shown).

Risk level 535 indicates the level of trading aggressiveness associated (e.g., on a scale of 1 to 10, with 10 reflecting the highest aversion to risk, and therefore the most aggressive trading strategy) based on the value entered in a risk preference field. When a higher risk reference value is used, the 4CAST algorithm submits orders in bigger blocks (e.g., more aggressively) rather than spreading the order submission out over the course of the day. This reduces the risk, since the cost of these transactions will be closer to the known (estimated) cost. If trading were otherwise extended over the course of the day, the trade could be at risk to a greater change in the cost.

Graphs 540 and 560 provide different perspectives of the analysis of the desired securities order. Each graph is intended to provide a visual indication of various aspects of the pre-trade analysis of the desired securities order. Graph 540 includes a time horizon along one axis and a cost scale along the other axis thereof. Graph 540 graphs the cost 550 and the risk 545 in a visually appealing and understandable format, as shown. The total projected cost estimation for submitting the order using the selected and/or used securities trading algorithm 520 is captured in graph line 555. Graph 560 provides yet another view of the analysis data.

It should be appreciated that the graphical representations provided in the display of the user interface may vary depending on the selected securities trading algorithm 520 used. Note, that any one of the plurality (Strategyₙ) of securities trading algorithms 565 may be-selected for use in the analysis according to the methods herein.

The plurality of securities trading algorithms 565 may include different securities trading algorithms such as: an algorithm that may simulate working the order over a short duration with the objective of capturing the immediate spread at the time of entry; an algorithm that scans for hidden liquidity between the spread on all major electronic markets without posting the order; an algorithm that scans for hidden liquidity between the spread on all major electronic markets and then posts the order; an algorithm that scans to get the fastest execution possible with limit price protection—executions that can occur outside the NBBO; etc.

These and other algorithms may be used in conjunction with pre-trade analytics, and preferably are also used in conjunction with executing trades. Pursuant to some embodiments, traders may utilize the pre-trade analytics to identify the most desirable (projected) trade. Guidance regarding submitting a trade may be based, at least in part, on the analysis provided by the methods and systems herein.

In some embodiments, different algorithms may be used in conjunction with a number of different order types, including common order types as well as order types specific to certain markets and regions. For example, U.S. orders (4Cast, Smart Market, Smart Limit, Chunk, Participate, IXP Trigger, VWAP and Stop Orders); European orders (e.g., VWAP, Participate, Auction, and Stop Orders), etc.

In some embodiments, the systems and methods herein may allow analytics and trading with a number of destinations, including a number of uncommon destinations such as Chicago Futures Exchange (CFE), EUREX US Boston Options Exchange (BOX), NASDAQ Closing Cross & Imbalance information (i.e., similar to NYSE, users can enter orders ahead of close or against the displayed imbalance).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method comprising:
receiving user input that indicates a desired securities order to evaluate;
identifying a desired level of risk to associate with the desired securities order to evaluate;
analyzing the desired securities order based on the desired level of risk using at least one of a plurality of securities trading algorithms; and
displaying an information screen depicting information associated with the desired securities order based on the analyzing, wherein the information screen provides a graphical representation of the analysis prior to an execution of the desired securities order.

2. The method of claim 1, wherein the at least one of the plurality of securities trading algorithms used in the analyzing is selectively designated by a user.

3. The method of claim 1, further comprising providing the at least one of the plurality of the securities trading algorithms used in the analyzing.

4. The method of claim 1, wherein the user input further includes identifying a desired time span for evaluating the desired securities order for the analyzing thereof.

5. The method of claim 1, further comprising selectively executing, after the analyzing, the desired securities order.

6. The method of claim 1, wherein the information associated with the desired securities order comprises a graphical display of estimated transaction cost and an associated time span.

7. The method of claim 1, wherein the information screen further comprises, at least, a graph of at least one of a cost estimate, a projected execution profile, and combinations thereof.

8. The method of claim 1, wherein at least a portion of the user input to be received is based on an attribute of the desired securities order to evaluate.

9. The method of claim 8, wherein the attribute is selected from the group consisting of: a security type, a number of securities in the desired securities order, a market destination, a type of exchange for the desired securities order, whether the desired securities order is to be evaluated from a buy side or a sell side, a time span for evaluating the desired securities order, and any combinations thereof.

10. A system comprising:
a processor; and
a storage device in communication with the processor and storing instructions adapted to be executed by the processor to:
receive user input that indicates a desired securities order to evaluate;
identify a desired level of risk to associate with the desired securities order to evaluate;
analyze the desired securities order based on the desired level of risk using at least one of a plurality of securities trading algorithms; and
provide display data representative of an information screen depicting information associated with the desired securities order based on the analyzing, wherein the information screen provides a graphical representation of the analysis prior to an execution of the desired securities order.

11. The system of claim 10, wherein the plurality of securities trading algorithms are each implemented as substantially independent modules for interfacing with the processor.

12. The system of claim 11, wherein each of the substantially independent modules includes an interface compatible with a communication interface of the processor.

13. The system of claim 10, wherein the storage device comprises at least one of historical information and substantially real-time information, relevant to evaluating the desired securities order using the at least one of the plurality of the securities trading algorithms.

14. The system of claim 10, further comprising a display device for presenting the graphical representation of the analysis.

15. The system of claim 10, wherein the at least one of the plurality of securities trading algorithms used in the analyzing is selectively designated by a user.

16. The system of claim 10, further comprising storing instructions adapted to be executed by the processor to provide the at least one of the plurality of the securities trading algorithms used in the analyzing.

17. The system of claim 10, further comprising storing instructions adapted to be executed by the processor to, after the analysis, execute the desired securities order.

18. The system of claim 10, further comprising storing instructions adapted to be executed by the processor to provide a user-selectable option to facilitate accepting or declining, after the analysis, executing the desired securities order.

19. The system of claim 10, wherein at least a portion of the user input to be received is based on an attribute of the desired securities order to evaluate.

20. The system of claim 19, wherein the attribute is selected from the group consisting of: a security type, a number of securities in the desired securities order, a market destination, a type of exchange for the desired securities order, whether the desired securities order is to be evaluated from a buy side or a sell side, a time span for evaluating the desired securities order, and any combinations thereof.

21. An article, comprising:
a storage medium having stored thereon instructions that when executed by a machine result in the following:
receiving user input that indicates a desired securities order to evaluate;
identifying a desired level of risk to associate with the desired securities order to evaluate;
analyzing the desired securities order based on the desired level of risk using at least one of a plurality of securities trading algorithms; and
displaying an information screen depicting information associated with the desired securities order based on the analyzing, wherein the information screen provides a graphical representation of the analysis prior to an execution of the desired securities order.

22. The article of claim 21, wherein the at least one of the plurality of securities trading algorithms used in the analyzing is selectively designated by a user.

23. The article of claim 21, further comprising instructions stored thereon that when executed by a machine result in providing the at least one of the plurality of the securities trading algorithms used in the analyzing.

24. The article of claim 21, wherein the user input further includes identifying a desired time span for evaluating the desired securities order for the analyzing thereof.

25. The article of claim 21, further comprising selectively executing, after the analyzing, the desired securities order.

26. The article of claim 21, wherein the information associated with the desired securities order comprises a graphical display of estimated transaction cost and an associated time span.

27. The article of claim 21, wherein the information screen further comprises, at least, a graph of at least one of a cost estimate, a projected execution profile, and combinations thereof.

28. The article of claim 21, wherein at least a portion of the user input to be received is based on an attribute of the desired securities order to evaluate.

29. The article of claim 28, wherein the attribute is selected from the group consisting of: a security type, a number of securities in the desired securities order, a market destination, a type of exchange for the desired securities order, whether the desired securities order is to be evaluated from a buy side or a sell side, a time span for evaluating the desired securities order, and any combinations thereof.
